(19) United States
(12) Patent Application Publication
(10) Pub. No.: US 2017/0343788 A1
(43) Pub. Date: Nov. 30, 2017

(54) HIGH-PRESSURE-RESISTANCE SPECIMEN CHAMBER FOR TRANSMITTED LIGHT MICROSCOPY AND METHOD FOR PRODUCING SAME

(71) Applicant: Alfred-Wegener-Institut Helmholtz-Zentrum fuer Polar- und Meeresforschung, Bremerhaven (DE)

(72) Inventors: Erich Dunker, Schiffdorf (DE); Jutta Wollenburg, Hechthausen-Bornberg (DE)

(21) Appl. No.: 15/535,428

(22) PCT Filed: Dec. 4, 2015
(86) PCT No.: PCT/DE2015/000577

§ 371 Date: Jun. 13, 2017

(30) Foreign Application Priority Data
Dec. 15, 2014 (DE) 10 2014 018 858.2

(51) Int. Cl. G02B 21/34; B01L 3/00; G01N 21/03

(52) U.S. Cl. CPC G02B 21/34; G01N 21/0317; B01L 3/508; G01N 21/0332; B01L 2200/025; B01L 2300/168; B01L 2200/0689; G01N 2021/0385; G01N 2021/0389

(57) ABSTRACT

A specimen chamber for transmitted light microscopy includes a chamber body having a specimen space that is sealed off in a transmitted light direction on opposite sides by transparent first and second observation windows, respectively, a seal being interposed in each case. First and second clamping elements are configured to fix the two observation windows to the specimen space. The clamping elements comprise observation openings into the specimen chamber. The first observation window comprises a first plane-parallel shoulder that protrudes into the first observation opening of the first clamping-element so as to fit exactly. The second observation window comprises a second plane-parallel shoulder that protrudes into the second observation opening of the second clamping element so as to fit exactly. The two seals are resistant to high pressure. The observation windows and the seals each consist of a plastomer.

### CROSS-REFERENCE TO PRIOR APPLICATIONS

This application is a U.S. National Stage Application under 35 U.S.C. §371 of International Application No. PCT/DE2015/000577 filed on Dec. 4, 2015, and claims benefit to German Patent Application No. DE 10 2014 018 858.2 filed on Dec. 15, 2014. The International Application was published in German on Jun. 23, 2016 as WO 2016/095887 A1 under PCT Article 21(2).

### FIELD

The invention relates to a specimen chamber for transmitted light microscopy comprising at least one chamber body having a specimen space that is sealed off in the transmitted light direction on opposite sides by means of a first transparent observation window and by means of a second transparent observation window, a seal being interposed in each case, and having a first clamping element and a second clamping element for fixing the two observation windows to the specimen space, the first clamping element comprising a first observation opening and the second clamping element comprising a second observation opening into the specimen chamber, and to a method for producing a specimen chamber of this kind.

### BACKGROUND

The specimen space of specimen chambers of this kind can have a volume of from a few milliliters to several liters and can in particular receive fluid specimens. Said specimens can then be observed over a long period of time. The specimens can be cell cultures for example, the growth of which, including under specific conditions that can be set in the specimen chamber, is intended to be observed. In transmitted light microscopy, the specimen space is transilluminated from one side by a light source and observed from the opposite side using a microscope. In a vertical arrangement, the microscope is usually located above, and the light source below, the specimen chamber. However, a horizontal arrangement is also easily possible.

DE 101 16 938 C1 discloses a specimen chamber for transmitted light microscopy that is intended for receiving and supplying cell cultures, the specimen chamber having the dimensions of a commercially available microscope slide. The specimen space is located in a chamber body and is covered by a first observation window, a seal being interposed. The first observation window is fixed to the specimen space in the chamber body by means of a first clamping element and a spacer plate. A second observation window is arranged on a second clamping element on the opposite side of the chamber body. The two clamping elements are formed integrally as a clamping bracket that surrounds the entire specimen chamber and fixes the two observation windows. Above the observation window, the clamping elements comprise observation openings in the form of cut-outs. The seals consist of silicone and seal by means of elastic deformation when contact pressure is applied. The observation windows are very thin and are not resistant to high pressure above atmospheric pressure.

DE 101 48 210 B4 discloses a specimen chamber for light microscopy examinations of liquids, in which two cylindrical liquid reservoirs are arranged in a transparent base plate, the underside of which comprises connecting channels. The liquid reservoirs and the base plate are formed integrally and consist of polycarbonate, which is a high-quality plastics material that does not exhibit any double refraction or any autofluorescence. Production is carried out by means of injection molding.

DE 203 11 434 U1 discloses a specimen chamber for microscopic observation of objects under high pressure, in which good optical resolution is intended to be achieved even at a high pressure—up to 30 kN/cm² (corresponding to 3000 bar). For this purpose, precisely ground-in observation windows having a low optical density are used. Clamping elements for fixing the panes are omitted, since the observation windows narrow conically with distance from the specimen chamber. At lower pressures, the specimen chamber is sealed by a resilient O-ring, and at higher pressures said chamber is sealed by a progressive metal seal. In this case, the metal seal is formed by a cover element that is screwed to the main body.

DE 20 2008 010 895 U1 discloses a specimen chamber for microscopic observations, in which the specimen space is formed by a polytetrafluoroethylene ring comprising a projection. A stainless steel threaded ring overlaps the projection and fixes the specimen space to the chamber body. In this case, the threaded ring is tightened only sufficiently to ensure that the bottom of the specimen chamber is sealed with respect to liquid. Correspondingly, only one lower observation window is provided, with the interposition of a sealing ring, for sealing the specimen space. The specimen space is open at the top. It is therefore not possible for the specimen to be subjected to pressure above atmospheric pressure.

Furthermore, DE 10 2010 002 915 B4 discloses a microfluidic sensor in which a specimen chamber structured by means of webs is arranged above a main sensor. Said chamber consists of polycarbonate and is produced in a deep-drawing method by means of flow liquefaction and plastic deformation. However, said chamber cannot be used as a specimen chamber that is subjected to pressure.

Furthermore, DE 198 03 551 C1 discloses a temperature-control cell for heating or cooling a specimen to be examined under a microscope, which cell comprises a specimen space that has two observation windows and can be set to a desired temperature by means of electrical heating elements and cooling ducts through which a coolant flows. The temperature-control cell is resistant to high pressures, the observation windows, which are rectangular in cross section, being adhesively bonded to the inside of the specimen space on a window fitting that is secured by lock nuts, and being sealed by means of a self-reinforcing metal seal.

US 2006/0045821 A1 discloses a microreactor for in situ material observation in transmitted light having an adjustable pressure (high pressure of up to 4500 psi, corresponding to 3.1 kN/cm²). The two observation windows having a rectangular cross section are each clamped between two high-pressure-resistant sealing rings. US 2008/0083268 A1 discloses a similar apparatus in which the two observation windows, which are also rectangular in cross section, are pressed against a shoulder in the housing. DD 51 714 A1 further discloses an apparatus for microscopic transmitted light examination under increased pressure (up to 25 kp/cm², corresponding to 0.25 kN/cm²), in which the rear rectangular shape of two observation windows is fitted into the housing. One of the observation windows is also formed so as to be rectangular towards the specimen space, whereas the other observation window is spherical there. Finally, EP 0 458 672 A1 also discloses a high-pressure chamber (15 GPa, corresponding to 1500 kN/cm²) for transmitted light microscopy, in which the two crystalline observation windows are conical, the cone apexes being oriented towards the specimen space. The circular base surfaces of the two observation windows are fitted into shoulders in the housing by means of sealing rings.

### SUMMARY

In an embodiment, the present invention provides a specimen chamber for transmitted light microscopy. At least one chamber body has a specimen space that is sealed off in a transmitted light direction on opposite sides by a transparent first observation window and by a transparent second observation window, a seal being interposed in each case. A first clamping element and a second clamping element configured to fix the two observation windows to the specimen space. The first clamping element comprises a first observation opening and the second clamping element comprises a second observation opening into the specimen chamber. The first observation window comprises a first plane-parallel shoulder that protrudes into the first observation opening of the first clamping element so as to fit exactly. The second observation window comprises a second plane-parallel shoulder that protrudes into the second observation opening of the second clamping element so as to fit exactly. The two seals are resistant to high pressure. The observation windows and the seals each are made of a plastomer.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a cross section of a high-pressure-resistant specimen chamber according to an embodiment of the invention,

FIG. 2 is a plan view of the high-pressure-resistant specimen chamber,

FIG. 3A shows a first step in a method sequence according to an embodiment of the invention,

FIG. 3B shows a second step in the method sequence, and

FIG. 3C shows a third step in the method sequence.

### DETAILED DESCRIPTION

An embodiment of the invention provides an improved specimen chamber which permits transmitted light microscopy examinations of substances in the specimen space under high pressure, in particular in a range above 100 bar (corresponding to 1 kN/cm²). In the process, however, the microscopic view into the specimen chamber should be kept optimal, and in particular distortion and refraction through the corresponding observation window should be prevented. At the same time, however, the observation windows should be fixed to the specimen space so as to be secure, even at high pressures. A preferred method for producing the specimen chamber is intended to be particularly simple and cost-effective. In particular, no special tools should be necessary.

According to an embodiment of the invention, the specimen chamber is characterized in that the first observation window comprises a first plane-parallel shoulder that protrudes into the first observation opening of the first clamping element so as to fit exactly, and the second observation window comprises a second plane-parallel shoulder that protrudes into the second observation opening of the second clamping element so as to fit exactly, and in that the two seals are resistant to high pressure, the observation widows and the seals each consisting of a plastomer.

The observation opening of the first clamping element forms the viewing region for the microscope into the specimen chamber. On account of the plane-parallel shoulder, the first observation window is fitted exactly into the observation opening of the first clamping element and cannot slip laterally in the chamber body, even when high pressure is applied. At the same time, the plane-parallel design of the shoulder does not impede the view into the specimen chamber, and in particular does not produce any distortions. A plane-parallel shoulder of the second observation window protrudes into the observation opening of the second clamping element. Since the light is guided into the specimen space from this side (in general the lower side of the specimen chamber in the case of a vertical transmitted light direction), it is not essential for the observation window to have a distortion-free surface here. The second shoulder primarily ensures that the second observation window is securely fitted on the specimen space. The exactly fitted integration of the shoulders into the clamping elements already ensures a good fit. In the pressure chamber according to an embodiment of the invention, sealing is achieved even at high pressures by providing high-pressure-resistant plastomer seals. In this case, the high pressure range is generally defined as being a pressure of 100 bar (corresponding to 1 kN/cm²) or more. The specimen chamber according to an embodiment of the invention can be optimally used in a range of between 200 and 1000 bar (corresponding to 2 to 10 kN/cm²) for example, in particular at 500 bar (corresponding to 5 kN/cm²). It is, of course, also possible to use the specimen chamber according to an embodiment of the invention at lower pressures (low pressure range of between 1 bar and 65 bar (corresponding to 0.01 kN/cm² to 0.65 kN/cm²) and medium pressure range of between 65 bar and 100 bar (corresponding to 0.65 kN/cm² and 1 kN/cm²)) or at atmospheric pressure, the optimal viewing possibility into the specimen chamber through the undistorting, transparent plastomer observation window also being particularly advantageous in this case.

Cell cultures, bacteria, micro-organisms or small metazoans, for example, can be conditioned, optically monitored and documented in a physiologically accurate manner using the specimen chamber according to the invention. This makes it possible to balance oxygen depletion rates, for example, of different animal groups under specific pressure conditions at different water depths, as well as to microscopically observe cellular processes under variable pressure conditions. Another possible application consists in blood analysis under pressure, as is often required for professional divers for example.

In the specimen chamber according to an embodiment of the invention, a plastomer is used as the material for the two observation windows and the seals, the plastomer for the observation windows of course being transparent. Plastomers are characterized in that they react to pressure application by plastically deforming. After being shaped, plastomers are subject to internal stresses. When pressure is applied, said plastomers begin to plastically deform (this may also be referred to as “flowing”) in order to equalize the stresses, the degree of plastic deformation being dependent on the amount of pressure applied and the shape of the plastomer. The plastic deformation that develops is then retained after the internal stresses have been equalized, and can be loaded again up to the level of the pressure application that has occurred. When a higher pressure is applied, the plastomer deforms again until the internal stresses have been equalized, and is then permanently dimensionally stable up to this higher pressure. The plastic deformability of the plastomer makes a particularly simple production method possible, which method will be described below. The plastomer for the two observation windows can preferably be polycarbonate, which is supertransparent and is particularly suitable as a viewing window for microscopy. Polycarbonate is very creep-resistant and is therefore permanently very dimensionally stable, but also exhibits good plastic deformation under corresponding pressure application. Polytetrafluoroethylene, which also belongs to the group of the plastomers, is preferably and advantageously used for the seals. Polytetrafluoroethylene (PTFE, trade name TEFLON) is not transparent, but has good sliding and lubrication properties and is very suitable as a sealing material. Selecting a plastomer for the seals mean that said seals also plastically deform when pressure is applied. In this case, the plastic deformation takes place towards the space surrounding the seals, with the result that said space is securely, reliably and permanently sealed when high pressure is applied. In this case, plastically adapting seals have a significant advantage compared with elastically adapting seals in terms of their sealing effect. In the preferred method for producing the specimen chamber, the plastic deformability of the seals is also significant, as will be set out below.

In the case of a plastomer, the degree of plastic deformation depends on the material itself and also on the material thickness of the element formed. Low material thicknesses deform more under pressure than higher thicknesses. In the specimen chamber, the first observation window is preferably thicker than the second observation window. The first (upper) observation window generally forms the viewing window for the microscope. It is important that no distortion should occur here. When the observation window is thicker, less plastic deformation occurs when pressure is applied, and therefore the resulting shoulder that protrudes into the first opening of the first clamping element is accordingly flat and plane-parallel. During subsequent use, the light generally passes through the second (lower) observation window, and optical distortions are less relevant. Therefore, the second observation window can be thinner, with the result that it also exhibits greater plastic deformation when pressure is applied. This results in a larger plane-parallel shoulder that fits very precisely and that ensures high dimensional stability of the specimen chamber even when very high pressures are applied. The reverse relationship is easily possible if the microscope and light source are swapped.

A favorable shape, also in terms of assembling the specimen chamber, results if, advantageously and preferably, the specimen space, the two observation windows, the two clamping elements and the two seals are cylindrical. Then, advantageously, the two clamping elements can each comprise an external thread by means of which they are screwed into internal threads in the chamber body. This allows particularly good resistance to high pressures, as well as simple assembly and maintenance of the specimen chamber. In the specimen chamber, the seals can preferably and advantageously be inserted in sealing grooves in the chamber body, the sealing grooves surrounding the specimen space in a closed manner. Annular sealing grooves having a rectangular cross section, for example, are commercially available and can be inexpensively obtained.

Simple filling and emptying of the specimen chamber can be achieved if, advantageously and preferably, high-pressure-resistant supply channels and discharge channels are arranged in the chamber body, which channels make it possible to supply the specimen chamber and/or allow circulation through the specimen chamber. In this case, the medium to be supplied and/or circulated is a fluid, generally a liquid. The specimen chamber can therefore, under parameterizable boundary conditions, also be used as a flow chamber, in particular also for long-term observations. Oxygen and food, for example, can be supplied to living organisms via the channels. In this case, it is preferable and advantageous for heating and/or cooling elements to also be provided for the specimen space. The specimen space can then also be cooled or heated in a controlled manner for optimally conditioning living organisms. Since many organisms that are to be examined are so small that they migrate from the specimen space or are washed out during flow operation, it is advantageous and preferred for a water-permeable annular filter to be provided in the specimen space around the transmitted light direction over the entire height of the specimen space. The organisms are then located inside the annular filter and thus exactly in the observation region. The organisms cannot escape from the annular filter through the upper and lower connection of the annular filter to the specimen space, although said filter can be thoroughly rinsed through with water. A reliable, but also very fine porosity is in particular advantageously and preferably achieved when the annular filter consists of a sintered material which is in addition also resistant to corrosion by water.

In the past, a number of cultivation trials on deep-sea benthic foraminifera have been successfully carried out under high pressure (up to 250 bar, corresponding to 2.5 kN/cm²) at the Alfred Wegener Institute. It has been possible to show that all the foraminifera species obtained using a core drill could be prompted to reproduce by means of the large-volume high pressure aquaria used here and the seawater circulation system. In comparison, this was achieved under atmospheric pressure in the case of only a few species that live in the sediment, and virtually no species that live on the sediment. In the experiments, the species Cibicides wuellerstorfi that was used for paleo-oceanographic reconstructions could only be reproduced in culture trials. Experimental breeding of this kind is the basis for the experimental calibration of a plurality of significant paleo-oceanographic proxies, for example stable isotopic ratios and trace metal ratios in carbonate shells of deep-sea benthic foraminifera.

Up to now, specimen spaces having volumes of up to 2.5 liters have been used. The specimen space of the specimen chamber provided in an embodiment of the present invention, however, is very small and can be in a range of just 0.2 ml for example. However, such a small volume is not entirely sufficient in order to microscopically observe bacteria, micro-organisms or small metazoans, for example. The specimen chamber according to the invention makes it possible for this observation to be carried out continuously over a very long period of time and under very high pressure, for example 500 bar (corresponding to 5 kN/cm²). Installing different valve groups and a high-pressure reciprocating pump makes it possible for isocratic, isobaric hydrologic cycles to be constantly carried out through the specimen chamber. Since the water can be continuously exchanged, the environmental conditions of the animals, bacteria or cell groups in the specimen chamber can be precisely defined and every small change can be documented, for example individual oxygen depletion rates for individuals at different pressures can be calculated, or reproduction time points can be recorded. Furthermore, oxygen, pH and other values can be kept constant in a simple manner. Since the specimen chamber is equipped with transparent panes on both sides, the individuals introduced or the medium introduced can constantly be visually monitored. When polycarbonate is used for the transparent panes, the optical parameters correspond to one another (polycarbonate: material density 1.2 to 1.24 g/cm³, refractive index 1.58; water: material density 1.0 g/cm³, refractive index 1.33), as a result of which there are no phenomena of refraction through the polycarbonate, and cell details can also be discerned. Moreover, polycarbonate does not adversely affect the results of fluorescence excitation and optical analysis.

The specimen chamber can be produced in a particularly simple manner by using observation windows and seals made of a plastically deformable plastomer. An advantageous and preferred method is characterized in that a transparent first faceplate without a shoulder and a transparent second faceplate without a shoulder are inserted in the specimen chamber with the interposition of sealing rings, the two faceplates and the sealing rings each consisting of a plastomer, the specimen chamber is subsequently fully assembled, and finally a sufficiently high pressure is applied to the specimen space that the two faceplates and the sealing rings plastically deform and form the first and second observation windows having plane-parallel shoulders, and the two high-pressure-resistant seals. The observation windows comprising the shoulders, and the high-pressure-resistant seals are thus produced in situ in the specimen chamber itself that is provided for the subsequent microscope operation. Complex production equipment or special tools are not required. In situ production allows the shoulders to be exactly fitted into the observation openings of the clamping elements in an optimal manner. Each pair of observation windows is individually fitted into the individual specimen chamber by high pressure being applied to said chamber after final assembly (using simple faceplates and sealing rings). It is nonetheless possible to disassemble the observation windows. Said windows can be replaced by new observation windows comprising shoulders in that new faceplates are inserted and correspondingly subjected to high pressure, and in turn form shoulders. The same advantages also apply for the seals, which also consist of a flowable plastomer. Preferably, polycarbonate is used for the faceplates and polytetrafluoroethylene PTFE for the sealing rings. When high pressure is applied, the sealing rings begin to flow between the chamber body and the faceplates and fill this space, as a result of which the sealing effect of said rings is significantly increased. The plastic deformation of the faceplates and the sealing rings is irreversible and dimensionally stable under any application of pressure that does not exceed the high pressure exerted during production. At higher pressures, further deformation occurs which is, however, again then also dimensionally stable up to these higher pressures. Forming the plane-parallel shoulders on one side of the faceplates results in minimal depressions on the opposing sides, which depressions, however, do not adversely affect the functionality of the observation windows formed.

In the method, the specimen space and thus the faceplates and the sealing rings can preferably and advantageously be subjected to a high pressure of between 2 kN/cm² (corresponding to 200 bar) and 15 kN/cm² (corresponding to 1500 bar), preferably to a high pressure of between 3 kN/cm² (corresponding to 300 bar) and 8 kN/cm² (corresponding to 800 bar), preferably to a high pressure of 5 kN/cm² (corresponding to 500 bar) in order for plastic deformation to be triggered. When a high pressure of 500 bar is exerted for example animals of which the habitat is 5000 m deep in the sea can be conditioned and microscopically examined at a high pressure of 500 bar in the subsequent microscope operation. All depths above 5000 m can then also be simulated in the specimen chamber. Correspondingly, when different high pressures are exerted, other habitat depths can be simulated in the specimen chamber. Simulation of more than 1500 m, for example up to 3000 m, are also possible. In contrast, it is of course also possible to set atmospheric pressure in order to simulate habitats that are close to the surface. There is a wide range of possible applications for the specimen chamber according to the invention. In particular, it is possible to observe living organisms over a long period of time by imitating their natural living conditions. In this case, it is appropriate to designate the specimen chamber according to the invention a “transmitted light high-pressure aquarium”. In the various applications, during microscopic examination, the specimen chamber according to the invention is subjected to a pressure that is between atmospheric pressure and the pressure that was applied to the specimen space during production in order to trigger plastic deformation. The specimen chamber is therefore very well suited for applications both at atmospheric pressure and at high pressure. When conditioning and observing very small living organisms, it is preferred and advantageous for an annular filter to be inserted into the specimen chamber, around the transmitted light direction, after one of the two faceplates and one of the two sealing rings have been inserted. The annular filter then extends along the transmitted light axis and keeps micro-organisms in the microscope field without impeding perfusion. Further details of the invention can be found in the following specific part of the description.

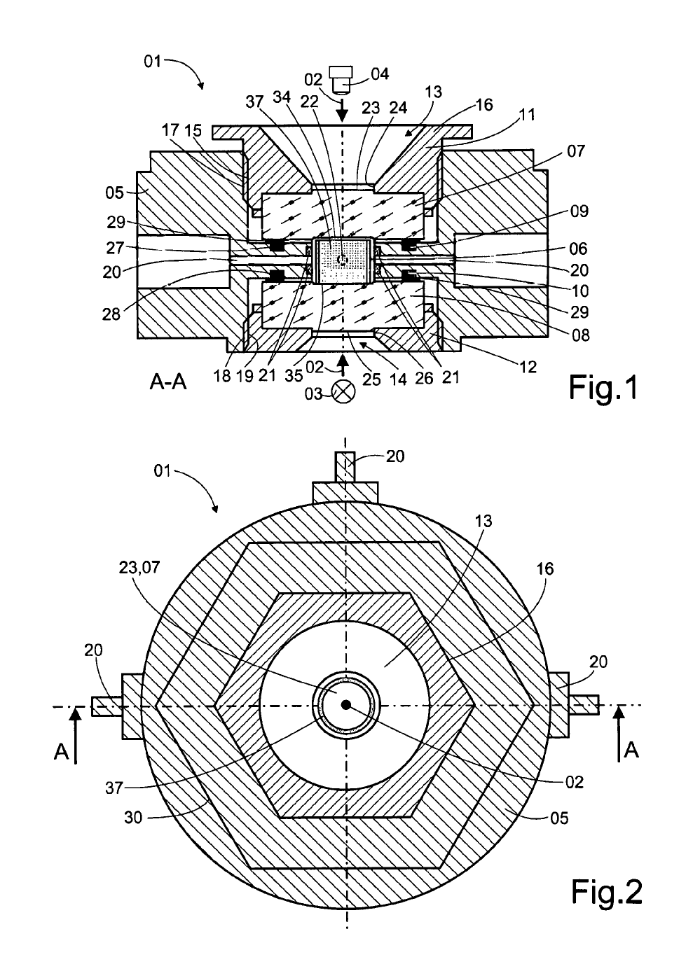

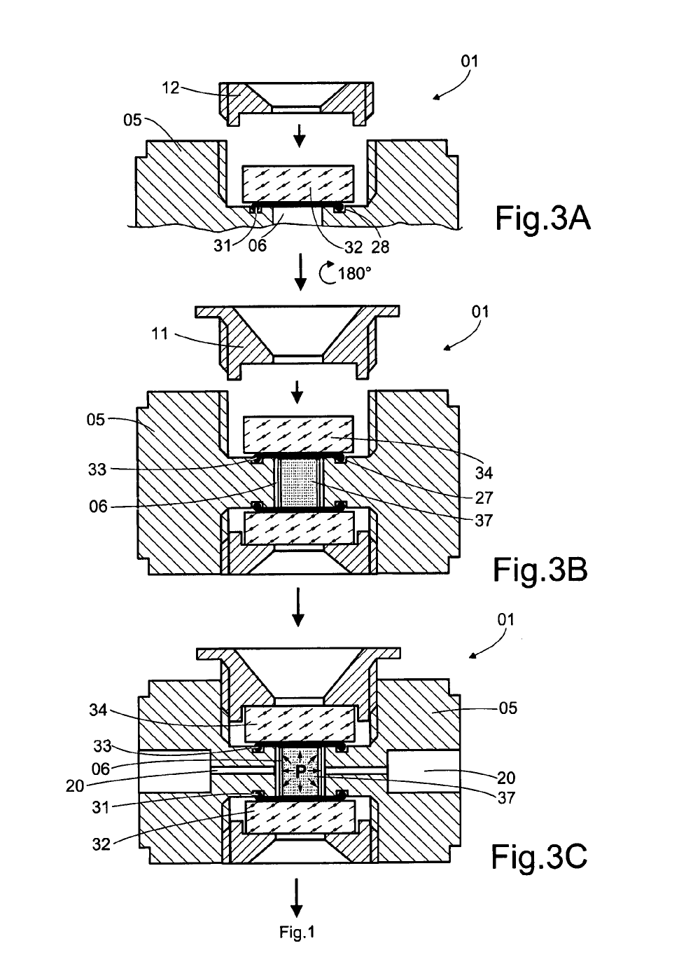

FIG. 1 shows a high-pressure-resistant specimen chamber 01 for transmitted light microscopy. In the embodiment shown, a vertical transmitted light direction 02 is selected, i.e. during microscope operation, a light source 03 is located below the specimen chamber 01 and transmits centrally through the specimen chamber 01, and a microscope 04, by means of which the specimen chamber 01 can be observed, is located above the specimen chamber 01. An inverted or horizontal or inclined arrangement of the transmitted light direction 02 is, however, also possible.

The specimen chamber 01 comprises a chamber body 05 having a central specimen space 06 that is sealed off in the transmitted light direction 02 on opposite sides by means of a transparent first observation window 07 and a transparent second observation window 08. A first high-pressure-resistant seal 09 and a second high-pressure-resistant seal 10 are interposed. The two observation widows 07, 08 are fixed to the specimen space 06 in a manner resistant to high pressure by means of a first clamping element 11 and a second clamping element 12. In this case, the first clamping element 11 comprises a first observation opening 13 and the second clamping element 12 comprises a second observation opening 14 into the specimen space 06. The clamping elements 11, 12 thus do not impede the transmitted light direction 02. In the embodiment shown, the specimen space 06, the two observation widows 07, 08, the two clamping elements 11, 12 and the two seals 09, 10 are cylindrical.

The first clamping element 11 comprises an external thread 15, by means of which said element is screwed, using an actuating element 16, into a first internal thread 17 in the chamber body 05. In the embodiment shown, the actuating element 16 is hexagonal (cf. FIG. 2), and is screwed into the chamber body 05 in a manner resistant to high pressure by means of a corresponding tool. Assembly and disassembly is thus easily possible. The second clamping element 12 comprises a second external thread 18, by means of which said element is screwed into a second internal thread 19 in the chamber body 05. The second clamping element 12 comprises, for example, a hexagon socket, and is also screwed into the chamber body 05 in a pressure-tight manner by means of a suitable tool. In this case, in the embodiment shown said element is screwed in so as to be flush, i.e. so as to terminate at the bottom with the chamber body 05, with the result that the entire specimen chamber 01 can be securely erected on a planar surface.

Furthermore, the specimen chamber 01 comprises a plurality of supply and discharge channels 20, for example also three pressure connections on three sides of the specimen chamber 01, by means of which the specimen chamber 05 can be supplied and can be subjected to high pressure. Cooling and heating elements 21 for cooling or heating the specimen chamber 05 are also shown in the selected embodiment. A chamber hole 22 in the center of the specimen space 05 indicates a further supply and discharge channel 20 in the specimen space 05; cf. FIG. 2. An annular filter 37 is arranged in the specimen space 06 around the transmitted light direction 02, which filter consists of a highly porous sintered material (also shown in cross section in FIG. 1). In the selected embodiment, the annular filter 37 has an external diameter of 8.8 mm when it has a wall thickness of 0.4 mm and a height of 5 mm. Extremely small organisms can be precisely and permanently conditioned in the transmitted light direction 02 inside the annular filter 37. Since the annular filter 37 is connected to the specimen space 06 at the top and bottom, the organisms cannot escape at the top and bottom either. However, water can nonetheless easily flow through the annular filter 37 perpendicularly to the transmitted light direction 02 on account of the porosity of said filter.

It can be seen in FIG. 1 that the first observation window 07 comprises a plane-parallel first shoulder 23 that protrudes into the first observation opening 13 so as to fit exactly. In the embodiment shown, the conical observation opening 13 comprises a first cylindrical extension 24 for this purpose. Moreover, the expression “fit exactly” is not intended to mean an exact fit according to DIN standards. Rather, it is intended to indicate that the plane-parallel first shoulder 23 fits very precisely into the first observation window 13 or the cylindrical extension 24 thereof. There are no gaps present, but instead an interference fit may even result. Similarly, the second observation window 08 also comprises a plane-parallel second shoulder 25 that protrudes into the second observation opening 14 so as to fit exactly. In this case, the second observation opening 14 is also conical and comprises a second cylindrical extension 26 in which the plane-parallel second shoulder 25 is received with an exact fit. An interference fit may result here, too. Opposite the first and second shoulders 23, 25, the observation windows 07, 08 comprise slight depressions 35, 36 that occur during production. However, in particular on the first observation window 07, the slight depressions 35, 36 do not impede viewing using the microscope, and do not produce any distortions that falsify the measured values.

In the selected embodiment, the two observation windows 07, 08 consist of supertransparent polycarbonate that has a density and a refractive index that are close to the density and the refractive index of water. As a result, no adverse distortion or refraction results during microscopic examination of aqueous substances. In the embodiment shown, the first observation window 97 has a thickness of 6 mm, whereas the second observation window 08 has a thickness of 5 mm. Accordingly, the thinner second observation window 08 exhibits greater plastic deformation during production than the thicker second observation window 07, and the second shoulder 25 is thicker than the first shoulder 23. The thinner second observation window 08 saves space in the lower region of the specimen chamber 01 and the thicker shoulder 25 improves the fit, while, in the upper region, the thinner shoulder 23 means that the view into the specimen space 06 remains unimpeded. In the selected embodiment, the specimen space 06 has a diameter of 9 mm and a height of 5 mm, and thus encloses a volume of 0.254 ml. In the selected embodiment, the overall specimen chamber 01 has a height of 25 mm and a diameter of 50 mm, and is therefore very compact and easy to handle.

The two seals 09, 10 consist of PTFE and are located in sealing grooves 27, 28 in the chamber body 05. A small gap 29 is formed between the two observation windows 07, 08 and the chamber body 05, which gap measures, for example, just 0.1 mm at the second observation window 08 and just 0.06 mm at the first observation window 07. Said gap 29 is filled by the first and second seals 09, 10 that plastically deform during production, with the result that the specimen chamber 01 is extremely high-pressure tight, even at high pressures of 500 bar and above.

FIG. 2 is a plan view of the specimen chamber 01, and shows the cutting plane AA for FIG. 1. It is possible to identify the cylindrical structure, comprising the chamber body 05 having a hexagonal shoulder 30 over which the specimen chamber 01 can be easily mounted in a corresponding apparatus. As a result, good stability of the specimen chamber 01 can be achieved during operation, in particular also under high pressure. The hexagonal actuating element 16 of the first clamping element 11 is also shown. The conical first observation opening 13 can be seen, into which opening the plane-parallel first shoulder 23 of the first observation window 07 protrudes so as to fit exactly. In the center of the first observation opening 13, the transmitted light direction 02 and the annular filter 37 surrounding said direction can be seen in the plan view. Three supply and discharge channels 20 are also shown, which channels are used as pressure connections.

FIGS. 3A, B and C schematically show different stages of the method sequence for producing the specimen chamber 01. In a first method step according to FIG. 3A, in step A a second sealing ring 31 made of PTFE and having a rectangular cross section, and a transparent polycarbonate faceplate 32 that does not have a shoulder and is completely planar, is inserted into the chamber body 05 or in the second sealing groove 28 in the region of the specimen space 06 and is fixed in a manner resistant to high pressure by means of the second clamping element 12 being screwed into the chamber body 05.

Subsequently, the chamber body 05 is rotated by 180° and, in a second method step according to FIG. 3B, the annular filter 37 made of sintered material, a first sealing ring 33 made of PTFE and having a rectangular cross section, and a first polycarbonate faceplate 34 that is also transparent and planar and thus does not have a shoulder, are inserted into the chamber body 05 or in the first sealing groove 27 in the region of the specimen space 06, and fixed by means of the first clamping element 11 being screwed into the chamber body 05. Assembly in the reverse sequence is likewise possible.

In a third method step according to FIG. 3C, the fully assembled specimen chamber 01 or the specimen space 06 is then placed over the high-pressure-resistant supply channels 20 under a high pressure (symbol “p” and arrows) that causes plastic deformation, for example under a high pressure of 500 bar, corresponding to 5 kN/cm². The two faceplates 32, 34 and the two sealing rings 31, 33 begin to flow. In the process, the two faceplates 32, 34 form the observation windows 07, 08 having the plane-parallel shoulders 23, 25, and the two sealing rings 31, 33 form the two seals 09, 10 according to FIG. 1. After the specimen space 06 has been relieved of the high pressure, the observation windows 07, 08 having the plane-parallel shoulders 23, 25, and the two sealing rings 09, 10 remain in the plastically deformed state thereof. This results in a high-pressure-resistant specimen chamber 01 that can be subjected, during microscope operation, to a pressure of between atmospheric pressure and a maximum of 500 bar (corresponding to the high pressure exerted during production).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

01 specimen chamber
02 transmitted light direction
03 light source
04 microscope
05 chamber body
06 specimen space
07 first observation window
08 second observation window
09 first seal
10 second seal
11 first clamping element
12 second clamping element
13 first observation opening
14 second observation opening
15 first external thread
16 actuating element
17 first internal thread
18 second external thread
19 second internal thread
20 supply and discharge channel, pressure connection
21 cooling and heating elements
22 chamber hole
23 first plane-parallel shoulder
24 first cylindrical extension
25 second plane-parallel shoulder
26 second cylindrical extension
27 first sealing groove
28 second sealing groove
29 gap
30 hexagonal shoulder
31 second sealing ring
32 second faceplate
33 first sealing ring
34 first faceplate
35 first depression
36 second depression
37 annular filter

1. A specimen chamber for transmitted light microscopy, comprising:
at least one chamber body having a specimen space that is sealed off in a transmitted light direction on opposite sides by a transparent first observation window and by a transparent second observation window, a seal being interposed in each case; and
a first clamping element and a second clamping element configured to fix the two observation windows to the specimen space, the first clamping element comprising a first observation opening and the second clamping element comprising a second observation opening into the specimen chamber,
wherein the first observation window comprises a first plane-parallel shoulder that protrudes into the first observation opening of the first clamping element so as to fit exactly,
wherein the second observation window comprises a second plane-parallel shoulder that protrudes into the second observation opening of the second clamping element so as to fit exactly, and
wherein the two seals are resistant to high pressure, the observation windows and the seals each being made of a plastomer.

2. The specimen chamber according to claim 1,
wherein the two observation windows are made of transparent polycarbonate, and the two seals are made of polytetrafluoroethylene.

3. The specimen chamber according to claim 1, wherein the first observation window is thicker than the second observation window.

4. The specimen chamber according to claim 1, wherein the specimen space, the two observation windows, the two clamping elements and the two seals are cylindrical.

5. The specimen chamber according to claim 4,
wherein the two clamping elements each comprise one external thread, respectively, by the clamping elements are each screwed into one internal thread, respectively, in the chamber body.

6. The specimen chamber according to claim 1, wherein the seals are inserted into sealing grooves in the chamber body, the sealing grooves surrounding the specimen space in a closed manner.

7. The specimen chamber according to claim 1, wherein high-pressure-resistant supply and discharge channels are arranged in the chamber body, the channels enabling to supply the specimen space and/or allow circulation through the specimen space.

8. The specimen chamber according to claim 1, wherein heating and/or cooling elements are provided for the specimen space.

9. The specimen chamber according to claim 1, wherein a water-permeable annular filter is disposed in the specimen space around the transmitted light direction over an entire height of the specimen space.

10. The specimen chamber according to claim 9,
wherein the annular filter consists of a sintered material.

11. A method for producing the specimen chamber according to claim 1, the method comprising:
inserting a transparent first faceplate without a shoulder and a transparent second faceplate without a shoulder in the specimen chamber, sealing rings being interposed in each case, the two faceplates and the sealing rings each being made of a plastomer; and then
fully assembling the specimen chamber; and then
applying a pressure to the specimen space such that the two faceplates and the sealing rings plastically deform and form the first and second observation windows having the plane-parallel shoulders, and the two high-pressure-resistant seals.

12. The method according to claim 11,
wherein the two faceplates consist of polycarbonate, and the two sealing rings are made of polytetrafluoroethylene.

13. The method according to claim 11,
wherein the pressure is between 2 kN/cm² and 15 kN/cm².

14. The method according to claim 13,
wherein the pressure is between 3 kN/cm² and 8 kN/cm².

15. The method according to claim 11,
wherein an annular filter is inserted into the specimen chamber, around the transmitted light direction, after one of the two faceplates and one of the two sealing rings have been inserted.
